(19) United States
(12) Patent Application Publication
(10) Pub. No.: US 2021/0409058 A1
(43) Pub. Date: Dec. 30, 2021

(54) ANTIMICROBIAL PHONE CASE

(71) Applicant: Johnson Copper LLC, Lake Winnebago, MO (US)

(72) Inventor: Lucas Johnson, Lake Winnebago, MO (US)

(21) Appl. No.: 17/304,717

(22) Filed: Jun. 24, 2021

Related U.S. Application Data
(60) Provisional application No. 62/705,377, filed on Jun. 24, 2020.

(51) Int. Cl. H04B 1/3888; A01N 59/20; A45C 1/06; A45C 13/00

(52) U.S. Cl. CPC H04B 1/3888; A45C 13/002; A45C 1/06; A01N 59/20

(57) ABSTRACT

A cover for a device that can provide antimicrobial protection is provided. The cover includes a case for enveloping an external device, an antimicrobial plate coupled to the case, and one or more protrusions provided on the antimicrobial plate for creating a physical separation between the antimicrobial plate and an external surface. The antimicrobial plate can be made of copper or a copper alloy that exhibit antimicrobial properties. Moreover, one or more magnets can be provided on the underside of the case to removably attach the case onto the external device. In certain embodiments, the case can be omitted and the antimicrobial plate can be directly coupled to the external device.

### CROSS-REFERENCE TO RELATED APPLICATION

This Application claims priority to U.S. Provisional Patent Application Ser. No. 62/705,377, filed on Jun. 24, 2020, entitled “Antimicrobial Phone Case”, the entire disclosure of which is incorporated herein by reference.

### BRIEF SUMMARY OF THE INVENTION

This disclosure generally relates to a case or cover for an electronic device. More particularly, the disclosure relates to a cover or a case for a mobile phone or tablet with an added layer for anti-microbial protection.

### BACKGROUND OF THE INVENTION

Electronic devices and smart devices, such as mobile phone, tablets, e-readers, pagers, and the like, have become popular in both a person's work and home life and are rarely out of sight. People carry their smart devices around the home, at work, and everywhere in-between. In fact, there are very few places where a person will not take a smart device. As such, smart devices are often and widely exposed to germs, viruses, and bacteria.

Most smart devices are coupled to or otherwise retained within a case or cover for protection. Cases and covers generally protect the smart devices from scratches, dents, and other damage. Protective cases and covers are typically made from plastics, rubber, and aluminum. While these cases and covers provide protection for the underlying device, they can also create potential harm for the user.

The materials used to construct cases and covers do little to protect the user from germs, viruses, and bacteria. Such contaminants can survive on cases for hours, or even days and weeks. Thus, cases must be continuously cleaned with cleaning wipes to remove such contaminants. But during the periods between cleanings, the user can be exposed to the germs, viruses, and bacteria located on the cover. This issue of contamination is multiplied for workers and patients in the healthcare field who are exposed to dangerous diseases more often than the general population.

Users of smart devices in education, hospitality, or general office space with shared collaborative spaces are likewise at risk because existing protective cases and covers can pick up contamination from dirty surfaces. Carry contaminated devices into a shared location and use or place such devices onto shared surfaces can aid the spread of such contamination through extended periods of time.

As such, there exists a need for a device cover or case that protects a user from germs, viruses, bacteria, and other contaminants. There is also a need for a cover or case that can actively cleans itself instead of merely slowing the growth of dangerous contaminants.

### BRIEF DESCRIPTION OF THE DRAWING

In the accompanying drawings, which form a part of the specification and are to be read in conjunction therewith in which like reference numerals are used to indicate like or similar parts in the various views:

FIG. 1 illustrates a perspective view of a cover according to an exemplary embodiment;

FIG. 2 illustrates a perspective view of a cover according to another exemplary embodiment;

FIG. 3A illustrates a front view of a cover according to yet another exemplary embodiment;

FIG. 3B illustrates a rear view of the cover of FIG. 3A;

FIG. 4 illustrates a cover according to another exemplary embodiment; and

FIG. 5 illustrates an antimicrobial plate according to an exemplary embodiment.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

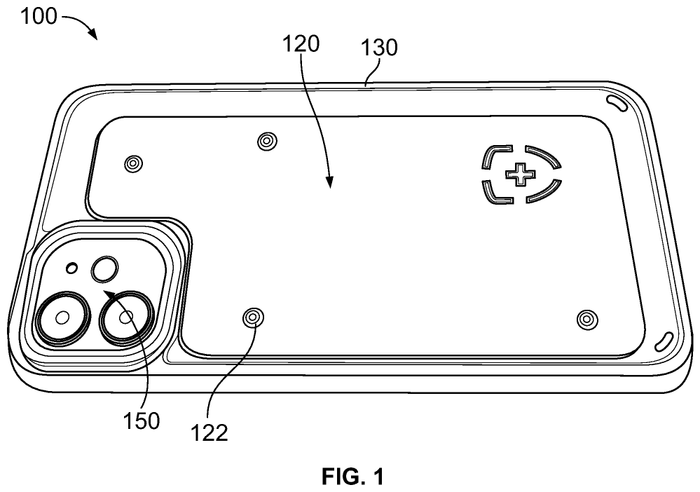

FIGS. 1-5 illustrate various exemplary embodiments of a cover according to the subject disclosure.

Referring to FIG. 1, a cover 100 is shown as a cover or a case for a device 150 such as a mobile phone. However, it is to be understood that the cover 100 can be adopted for many different devices such as tablets, e-readers, pagers, personal digital assistants (PDAs), wearable devices, personal computers, portable computers, and the like. Likewise, the cover 100 can also be adopted for use with more traditional phone systems such as a rotary phone or other landline phone.

The cover 100 can include a layer, sheet, laminate, or plate which can be used for anti-microbial, anti-germ, and/or anti-viral protection. In the embodiment illustrated in FIG. 1, the cover 100 includes a plate 120. It can be appreciated that the shape, design, or placement of such plate 120 may differ depending on the embodiment, and such design is not a limiting feature of the cover 100.

In one exemplary embodiment, the plate 120 can be constructed, manufactured, or otherwise made from a metal, metallic alloy, or other material that can act as an antimicrobial barrier. One such metal that the plate 120 can be made from is copper or any of its alloys, including but not limited to brass, bronze, cupronickel, copper-nickel-zinc, tin, and/or any combination thereof. Copper is an effective material for the plate 120 since copper does not lose its antimicrobial properties over time. However, it can be appreciated that other metals, non-metals, and/or synthetics can also be used to construct, manufacture, or make the plate 120, provided that such material can provide an antimicrobial, anti-viral, anti-bacterial, and/or anti-germ protection.

Copper, and other antimicrobials can act as an agent that can kill and/or inhibit the growth of microorganisms, such as viruses, bacteria, fungi, and or other microorganisms. Antimicrobials include, but are not limited to antibiotics, disinfectants, and antiseptics. Many such antimicrobials are synthetic or chemical in nature and are manufactured or otherwise produced. While the plate 120 can utilize any such antimicrobial material, copper is particularly advantageous and cost-effective, as copper has natural antimicrobial properties. In particular, certain copper alloys developed by Johnson Copper have been verified by governmental agencies such as the United States Environmental Protection Agency (EPA), as well as other independent studies, as being bactericidal or “bacteria-killing”. As such, the plate 120 can provide an antimicrobial layer of protection from germs, bacteria, viruses, and other contaminants. With its antimicrobial properties, the plate 120 can prevent germs, bacteria, viruses, and other contaminants from adhering to the plate 120, inhibit the growth of any such contaminants on plate 120, and/or eliminate any such contaminants on the plate 120.

In addition, the plate 120 can serve as a barrier or layer of protection for the device 150 contained therein and can help prevent or limit direct exposure of the device 150 to germs, bacteria, viruses, and other contaminants. The plate 120 can be placed in multiple locations and can be affixed either directly to the device 150 or to a case 130 in such a manner that prevents or limits exposure of the device 150 and/or the case 130 to contaminants.

In common situations, phones, tablets, and other devices are placed screen up on surfaces, such that the back of the device is in contact with the surface. To accommodate, the plate 120 can be located on the back of the device 150. Alternatively, phones, tablets, and other devices can also be placed screen down on surfaces, such that the front of the device 150 is in contact with a surface. To accommodate such instances, the plate 120 can additionally and/or alternatively be located on the front of the device 150. Even further, the plate 120 can additionally and/or alternatively be located on sides of the device 150, to provide even further protection. As such, it can be appreciated that many combinations of the plate 120 locations can be utilized, depending on the embodiment of the cover 100.

The configuration, shape, and size of plate 120 can also vary, depending on the embodiment. One such design of the plate 120 is illustrated in FIG. 1, and as depicted, can substantially cover the back surface of the device 150.

In this exemplary embodiment, the plate 120 can be sized in a manner such that it can cover the majority of the back surface of the device 150. In other embodiments, the plate 120 can completely cover the back surface of the device 150, leaving no portion of the back surface exposed. In a further embodiment, the plate 120 can cover less than a majority of the back surface of the device 150, leaving a majority of the back surface exposed. In alternate embodiments, the plate 120 can additionally or alternatively be located on the front surface of the device 150. In one such embodiment, the plate 120 can be placed around the edge of the front surface, leaving the screen, buttons, or components of the device 150 substantially unobstructed. In another embodiment, the plate 120 may alternatively or additionally be located on the sidewall(s) of the device 150.

Further, the plate 120 can be designed to correspond to the general shape of the device 150 or in other geometric shapes, including but not limited to, circular, triangular, square, rectangular, or other geometric shapes. The plate 120 can be constructed in a manner such that it does not interfere with the functions or use of the device 150. For example, as illustrated in FIG. 1, the plate 120 can be designed so that it does not cover, partially or completely, any camera, sound, or other components of the device 150. In one such embodiment, the plate 120 can comprise a generally rectangular design, with a carve out, indenture, and/or other opening to allow the camera component of the device 150 to remain unobstructed from the plate 120.

In an embodiment in which the plate 120 is located either partially or completely on the front of the device 150, the plate 120 can be positioned so that use of a screen, button, or other components of the device 150 are still usable. In an embodiment in which the plate 120 is located either partially or completely on one or more sides or sidewalls of the device 150, the plate 120 can be positioned so that the plate 120 does not interfere with the functions or usability of the device 150.

As shown in FIG. 1, the plate 120 can further comprise one or more protrusions 122, dimples, ridges, embossments, or other surface raisings. The protrusions 122 can provide further protection and antimicrobial functions by reducing, limiting, or eliminating the plate 120 or the device 150 surface area exposed to germs, bacteria, viruses, or other contaminants. By raising the plate 120 and/or the device 150 from the surface, there can be fewer points of contact between the plate 120 and/or the device 150 and germs, bacteria, viruses, and/or other contaminants. These decreased points of contact can further improve the antimicrobial effectiveness of the plate 120 and/or decrease the number of bacteria, viruses, germs, and/or other contaminants exposes to the plate 120 and/or the device 150. As such, the protrusions 122 can provide separation between the plate 120 and/or electronic the 150 in as little distance as 1 millimeters (mm) to several inches, depending on the embodiment.

The protrusions 122 can be comprised of a variety of shapes, numbers, and configurations, based on the embodiment of the cover 100, and present a non-limiting feature of the cover 100. In one such embodiment, the protrusions 122 can be comprised of a plurality of rounded tabs or bumps positioned near the outside edge of the plate 120. In another embodiment, one protrusion 122 can be positioned generally at the center of the plate 120. By way of a non-limiting example, the protrusion 122 can be a POPSOCKET® attachment or similar device. By way of another non-limiting example, the protrusion 122 can be comprised of five small bumps located at equidistant spaces apart along the outside edge of the plate 120. In an exemplary embodiment, the protrusion 122 can be comprised of an embossed or raised logo or design. Regardless of the size, shape, number, and/or configuration, the protrusions 122 can provide spacing and/or separation of the plate 120 and/or the device 150 from a surface.

The protrusions 122 can be constructed from numerous materials, again, depending on the embodiment of the cover 100. In one such embodiment, the protrusions 122 can be constructed from an antimicrobial material, including but not limited to, copper or a copper alloy, or alternatively, can be constructed from aluminum, rubber, or other synthetic material. In such an embodiment in which the protrusions 122 are constructed from an antimicrobial material, the protrusions 122 can provide additional antimicrobial protection in addition to and/or instead of providing space between plate the 120 and/or the device 150 from a surface.

Further, the protrusions 122 can be manufactured, constructed, or otherwise integrally made part of the plate 120. In such an embodiment, the protrusions 122 can be constructed during the manufacturing process of the plate 120 and can be permanently attached or otherwise connected to the plate 120. In alternate embodiments, the protrusions 122 can be constructed during the manufacturing process of the plate 120 but can be removable from the plate 120. In an even further embodiment, the protrusions 122 can be constructed or manufactured separately from the plate 120 and can later be affixed or otherwise attached to the plate 120. In such an embodiment, the protrusions 122 can be permanently affixed or connected to the plate 120. In an alternate embodiment, the protrusions 122 can be removably affixed or connected to the plate 120.

In one embodiment of the cover 100, the plate 120 can be used with the case 130 as shown in FIG. 1. The case 130 can be constructed using any methods of manufacture, and can be made from any materials, including but not limited to, plastics, rubbers, metals, synthetic materials, or other materials used to construct mobile phone or other electronic device cases. However, it will be appreciated that the case 130 also be constructed from copper, copper alloy, or other antimicrobial metals, nonmetals, or materials. In an embodiment in which the case 130 is constructed from copper or another antimicrobial material, the case 130 can provide the same protection and antimicrobial advantages as the plate 120 described herein.

The case 130 can be rigid yet flexible enough so that it can be fitted over the device 150 during installation. Thereafter, the device 150 can be encased within the cover 100 through the case 130 without being easily dislodged from the cover 100.

Depending on the embodiment, the plate 120 can be affixed, attached, or otherwise connected to case 130. Further, depending on the embodiment, the plate 120 may not be in direct contact with the device 150, or may be partially in contact with the device 150. Even further, the plate 120 can be permanently affixed, attached, or otherwise connected to the case 130, or the plate 120 can alternatively be removable from the case 130. As illustrated in FIG. 1, in one embodiment, the plate 120 can be located on an outer surface of the case 130, thereby limiting and/or preventing contact of the case 130 and/or the device 150 with a surface.

In an embodiment in which the plate 120 is separately attached to the case 130, the plate 120 can be applied using an adhesive material. However, the plate 130 may alternatively be attached or connected to the case 130 using any method of affixing, including but not limited to, mechanical methods such as screws or fasteners or other methods such as welding. In an alternative embodiment, the plate 120 can be connected to the case 130 during the manufacturing process, and can be affixed using an adhesive, mechanical method such as screwing or fastening, or other methods such as welding.

In an embodiment of the cover 100 comprising a cover 130, the plate 120 can be generally designed in a geometric shape to correspond to the geometric shape of the case 130. In such an embodiment, the plate 120 can further be designed to cover substantially the area of the case 130, or in alternate embodiments, can be designed to cover a majority of the area of the case 130, or less than a majority of the area of the case 130.

As illustrated in FIG. 1, in one embodiment, the plate 120 can be located on the back of the device 150, on the exterior surface of the case 130. Further, in such an embodiment, the plate 120 can be positioned and/or placed such that it is located on the back surface of the case 130, stopping short of the edge of the case 130. However, it can be appreciated that in alternate embodiments, the plate 120 can extend past the edge of the case 130 and/or can wrap around the case 130 and its sidewall. Certainly, the plate 120 can extend even further, extending around the sidewall of the case 130, extending to the front surface of the device 150 and the case 130. In an even further embodiment, the plate 120 can be located on the front surface of the case 130. Thus, it can be appreciated that any combination of location of the plate 120 on the case 130 can be used and are within the scope of this disclosure.

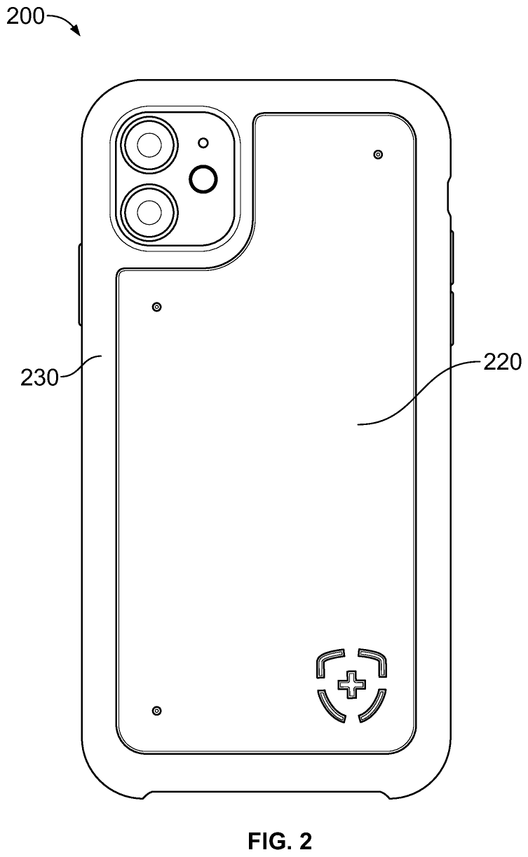

Referring to FIG. 2, a cover 200 is shown according to another exemplary embodiment. Here, a plate 220 can be affixed, attached, connected, molded to, or incorporated in case 230. In this case, instead of being a separate element affixed onto a surface of the case 230, the plate 220 can be embedded within the case 230, thus forming a substantially flush surface with the case 230. In an example, the case 230 can be formed out of rubber with a cutout therein that corresponds to a shape of the plate 220. Therefrom, the plate 220 can be placed within such cutout and affixed to the case 230 through conventional methods. Such an embodiment may be more aesthetically pleasing without the plate 220 substantially protruding out of the case 230, unlike the embodiment in FIG. 1.

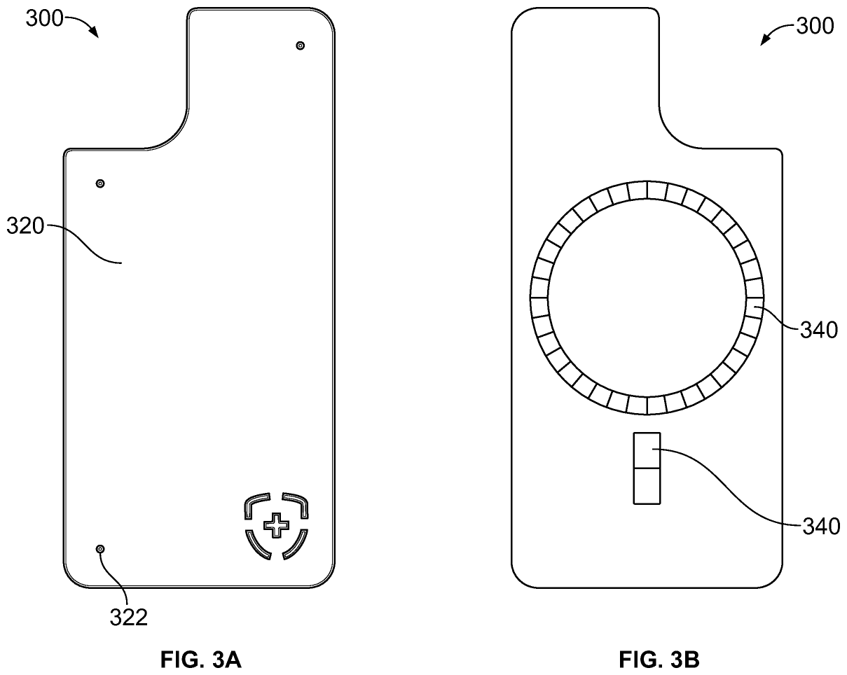

Referring to FIGS. 3A and 3B, a cover 300 shown according to yet another exemplary embodiment. In this example, a case as previously described can be omitted altogether. Instead, one or more magnets 340 can be used to affix the cover 300 onto a device. Thus, making the cover 300 compatible with APPLE's MagSafe or other similar technologies. As shown in FIG. 3A, a plate 320 can comprise of one or more dimples 322 just as before on its outward facing surface, i.e., the surface that is likely to be place on a table or be in contact with a user's hand. On the flip side, as shown in FIG. 3B, the backside of the cover 300 can comprise one or more magnets 340, allowing the cover 300 to be affixable to MagSafe compatible or similar devices. In this particular configuration, the cover 300 can more easily be removed from the device to accommodate for wireless charging when the device is not being carried in public. In further embodiments, the case 300 can also include a case similar to other embodiments described herein while also utilizing the magnets 340.

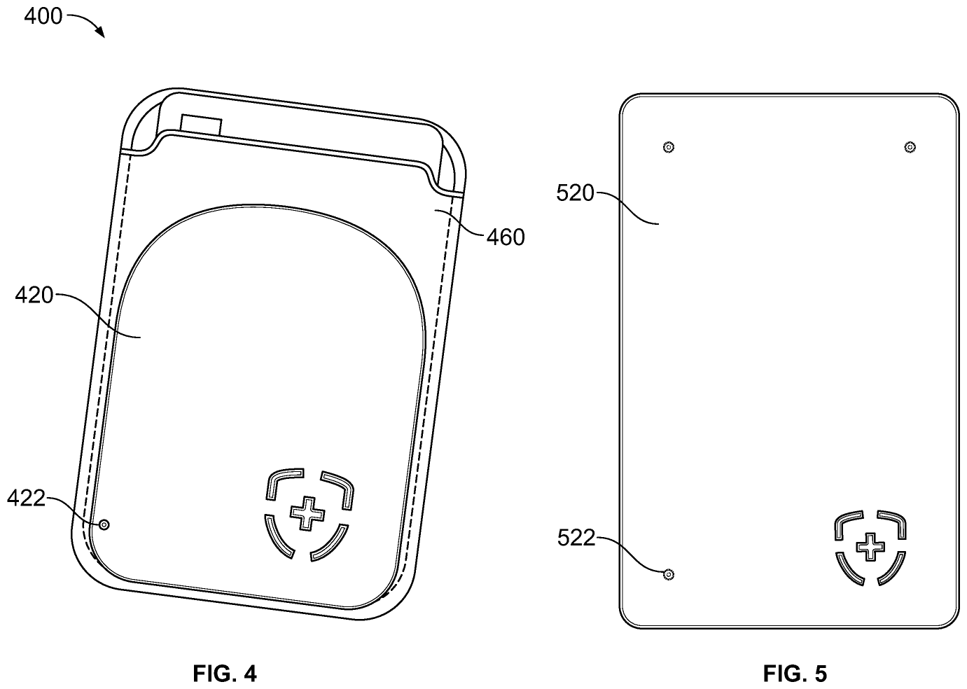

Referring to FIG. 4, another embodiment of a cover 400 is shown. In this configuration, instead of utilizing a more traditional case, other decorative or functional elements such as a wallet 460 can be used in conjunction with a plate 420. Here, the wallet 460 can be designed to hold paper currencies or credit cards. Similar to the embodiments where a case is utilized, the plate 420 can cover a substantial surface of the wallet 460, thereby provides antimicrobial protections to its users. In the embodiment as shown in FIG. 4, the cover 400 can be attached to a device using magnets similarly to the embodiment described in FIG. 3, thus enabling the cover 400 to be compatible with MagSafe or similar technologies. Moreover, just like the other embodiments, the plate 420 can further include one or more dimples 422. The plate 420 can be attached to the wallet 460 through any conventional method. Likewise, the wallet 460 can be made from a variety of materials, including antimicrobial materials such as copper.

FIG. 5 illustrates an embodiment of a standalone plate 520. In this configuration, a user may already have a cover for her device. However, such user may nonetheless wish to obtain the antimicrobial benefit offered by the plate 520 as described above. In this case, a standalone plate 520 can be used in conjunction with the user's existing cover. The plate 520 can also include dimples 522 for benefits previously explained. The plate 520 can be affixed onto the user's existing cover through methods such as adhesives, thus permitting the user to continue to utilize existing cover while also gaining antimicrobial benefits.

Although the embodiments described herein generally involve just one antimicrobial plate, it is to be appreciated that the embodiments can certain include more than one plate to achieve the same purpose. For example, more than one plates can be used to cover an exterior surface of a case, and one or more plates can be used to cover the side walls of the case. Thus, covers including multiple plates are also within the scope of this disclosure.

From the foregoing, it will be seen that this invention is one well adapted to attain all the ends and objects hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A cover for a device comprising:
a case; and
an antimicrobial plate coupled to the case.

2. The cover of claim 1, wherein the antimicrobial plate is constructed from copper or a copper alloy.

3. The cover of claim 1, wherein the antimicrobial plate includes at least one protrusion that provides a physical separation of the antimicrobial plate from an external surface.

4. The cover of claim 1, wherein the antimicrobial plate includes a plurality of protrusions that provide a physical separation of the antimicrobial plate from an external surface.

5. The cover of claim 4, wherein the plurality of protrusions includes at least two different types of protrusions.

6. The cover of claim 1, wherein the antimicrobial plate is coupled to the case using adhesive.

7. The cover of claim 1, wherein the case includes a first surface facing externally and a second surface facing internally,
wherein the antimicrobial plate is coupled to the cover on the first surface, and the cover abuts an external device on the second surface.

8. The cover of claim 7, wherein the second surface of the case includes at least one magnet.

9. The cover of claim 7, wherein the antimicrobial plate is integrally formed with the case, such that an external facing surface of the antimicrobial plate does not extend beyond the first surface of the case.

10. The cover of claim 1, wherein the case and the antimicrobial plate are made of different materials.

11. A cover for a device comprising:
an antimicrobial plate having a first surface facing externally and a second surface facing internally that abuts an external device; and
the second surface of the antimicrobial plate having at least one magnet that couples the antimicrobial plate to the external device.

12. The cover of claim 11, wherein the antimicrobial plate is constructed from copper or a copper alloy.

13. The cover of claim 11, wherein the antimicrobial plate includes at least one protrusion on the first surface that provides a physical separation of the antimicrobial plate from an external surface.

14. The cover of claim 11, wherein the antimicrobial plate includes a plurality of protrusions on the first surface that provides a physical separation of the antimicrobial plate from an external surface.

15. The cover of claim 14, wherein the plurality of protrusions includes at least two different types of protrusions.

16. A cover for a device comprising:
a wallet configured to store paper currencies therein, the wallet having a first surface facing externally and a second surface facing internally; and
an antimicrobial plate coupled to the first surface of the wallet;
wherein the second surface of the wallet includes at least one magnet for attaching the wallet to an external device.

17. The cover of claim 16, wherein the antimicrobial plate is constructed from copper or a copper alloy.

18. The cover of claim 16, wherein the antimicrobial plate includes at least one protrusion that provides a physical separation of the antimicrobial plate from an external surface.

19. The cover of claim 16, wherein the antimicrobial plate includes a plurality of protrusions that provides a physical separation of the antimicrobial plate from an external surface.

20. The cover of claim 19, wherein the plurality of protrusions includes at least two different types of protrusions.
